(19) United States
(12) Patent Application Publication
(10) Pub. No.: US 2026/0186380 A1
(43) Pub. Date: Jul. 2, 2026

(54) INTERCHANGEABLE MOUNT LENS

(71) Applicant: Guangdong Sirui Optical Co., Ltd., Zhongshan (CN)

(72) Inventors: Jie Li, Zhongshan (CN); Wei Zhang, Zhongshan (CN)

(73) Assignee: Guangdong Sirui Optical Co., Ltd., Zhongshan (CN)

(21) Appl. No.: 19/230,079

(22) Filed: Jun. 5, 2025

(30) Foreign Application Priority Data
Dec. 26, 2024 (CN) 202423247458.5

(51) Int. Cl. G03B 17/14

(52) U.S. Cl. CPC G03B 17/14

(57) ABSTRACT

A lens with an interchangeable bayonet comprises a lens body and a bayonet assembly, wherein the lens body comprises a lens barrel and a connecting barrel fixed as one body, and an axial debugging gap is provided between the connecting barrel and the lens barrel; the bayonet assembly comprises a bayonet solid barrel and a bayonet; the bayonet solid barrel is detachably connected to one side of the connecting barrel by a screw, the bayonet is fixedly connected to the bayonet solid barrel and may not be detached, and the bayonet is used to connect a camera.

### CROSS-REFERENCE TO RELATED APPLICATION

This application claims priority to a Chinese patent application serial number 202423247458.5, filed on Dec. 26, 2024, whose disclosure is incorporated by reference in its entirety herein.

### TECHNICAL FIELD

Aspects of the invention generally relate to the field of optical lens technology. In particular, embodiments of the invention relate to a lens with an interchangeable bayonet.

### BACKGROUND

Camera mounts from different brands vary in dimensions, flange spacing, and the number of electronic contacts, making them generally incompatible. To enable seamless connections between lenses and cameras with different mounts, manufacturers have developed adapters that allow users to install one brand's lens into another camera's mount. This innovation significantly expands the range of available lenses for photography enthusiasts.

Although the adapter may achieve a certain degree of physical compatibility between different brands of lenses and cameras, the adapter cannot completely eliminate the technical gap between brands. For example, there are obvious differences in autofocus, aperture control, image stabilization, lens correction and other aspects, and the adapter is often accompanied by compromises in these functions.

Traditional lenses, as shown in FIGS. 1 and 2, consist of a barrel housing the lens body \textcircled{1} and \textcircled{2}. The bayonet \textcircled{3} is secured to the lens body \textcircled{1} via screws. When the bayonet \textcircled{3} is fixed to the lens body \textcircled{1}, the gap \textcircled{4} between them is pre-adjusted. Once installed, the bayonet \textcircled{3} cannot be removed (removing it forcefully may alter the gap \textcircled{4}, affecting pixel quality). This design inherently prevents lenses from being disassembled or having their bayonets replaced. Furthermore, the flange distances \textcircled{5} between different bayonets and the imaging plane \textcircled{6} vary, which further restricts the possibility of replacing different bayonets.

Therefore, how to realize the replaceable design of the lens mount to match the use of different cameras, and the replacement of the mount hook will not affect the pixel quality of the lens, and there will be no damage and compatibility problems in the functional use of the lens are the technical problems that need to be solved urgently.

### SUMMARY

Therefore, the technical problem to be solved by the embodiments of the invention is to overcome the defects of the existing technology in which the lens on the card is not replaceable and may not match the use of different cameras, so as to provide a lens with an interchangeable card.

In order to solve the above technical problems, the technical scheme of the embodiments of the invention is as follows:
A lens with interchangeable bayonet, comprising:
The lens body includes a fixed lens barrel and a connecting tube, and an axial adjustment gap is provided between the connecting tube and the lens barrel;
The bayonet component includes a bayonet cylinder and a bayonet. The bayonet cylinder is detachably connected to one side of the connecting tube by screws, and the bayonet is fixedly connected to the bayonet cylinder and may not be disassembled. The bayonet is used to connect the camera.
Further, the card opening assembly further includes a sealing pad and a sealing ring disposed between the card opening solid cylinder and the card opening.
Further, the screw is a cross-shaped screw exposed on the outer surface of the lens.
Further, the card opening is any one of E card opening, Z card opening, RF card opening and L card opening.
Further, the lens barrel is a barrel for mounting the lens, and the connecting barrel is coaxially fixed to the axial end of the lens barrel.
Further, a housing cavity is formed between the card slot solid cylinder and the lens cylinder body, and the connecting tube is located in the housing cavity.
Furthermore, the lens barrel is provided with a stepped structure at its axial end adjacent to the snap-fit assembly. The connecting tube is fixedly connected to this stepped structure of the lens barrel. The connecting tube comprises: a main body sleeved around the central pillar of the lens barrel; a first connecting edge extending radially outward from one end of the main body; and a second connecting edge extending radially inward from the opposite end of the main body. The first connecting edge is positioned opposite to the axial end face of the lens barrel and secured by screws. The gap between the first connecting edge and the axial end face of the lens barrel serves as the axial adjustment clearance. The snap-fit solid cylinder is removably connected to the second connecting edge via screws, while maintaining a rigid connection between the snap-fit cylinder and the second connecting edge.
Furthermore, the axial end face of the lens barrel is provided with a limiting structure extending toward the bayonet assembly, and the limiting structure abuts against the peripheral wall of the first connecting edge.
Furthermore, the bayonet cylinder includes a fixing cylinder mounting portion for fixing the bayonet, and a fixing cylinder extension portion extending from the fixing cylinder mounting portion to the outer peripheral edge of the lens body and covering the outside of the connecting tube.
Further, the end of the extension portion of the fixing cylinder facing the lens barrel is provided with a stepped mating surface cooperating with the lens barrel.

This innovative technical solution offers the following advantages: The lens barrel and connecting tube are integrated into a single unit before factory assembly, with pre-adjusted axial clearance. When replacing lens mounts to match different cameras, simply remove the locking screw between the mount fixing tube and connecting tube for quick installation. By relocating the traditional pre-adjusted axial clearance between the lens mount and body to the barrel-connector interface, the mounted assembly becomes permanently fixed during replacement. This design prevents unauthorized disassembly, ensuring pixel quality remains unaffected by removal. The system also eliminates functional degradation or compatibility issues through interchangeable mounts, enabling seamless switching between focal length lenses in this series.

### BRIEF DESCRIPTION OF THE DRAWINGS

To better illustrate the specific embodiments of embodiments of the invention or technical solutions in existing technologies, we will briefly introduce the accompanying drawings used in the description. It is evident that the drawings described below represent some embodiments of embodiments of the invention. For ordinary skilled professionals in the field, additional diagrams may be derived from these illustrations without requiring inventive effort.

FIG. 1 shows the schematic diagram of the traditional lens bay structure of a prior art;

FIG. 2 shows the shape of a traditional lens of a prior art;

FIG. 3 is a schematic diagram of the structure of the interchangeable lens according to embodiments of the invention;

FIG. 4 shows the schematic diagram of the shape of the interchangeable lens according to embodiments of the invention;

FIG. 5 shows a disassembly and assembly diagram of the lens body and the clip assembly in the interchangeable clip lens according to an embodiment of the invention;

FIG. 6 shows the assembly diagram of the card component in the embodiment of the utility model;

FIG. 7 is a schematic diagram of the structure of the clasp fixing cylinder in an embodiment of the invention;

FIG. 8 is a schematic diagram of the structure of the card slot in an embodiment of the invention.

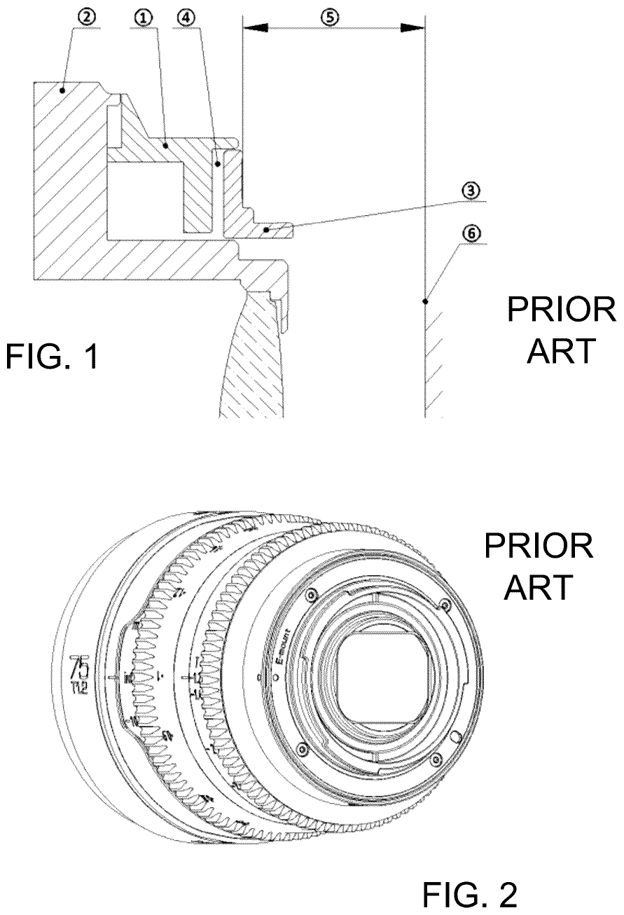

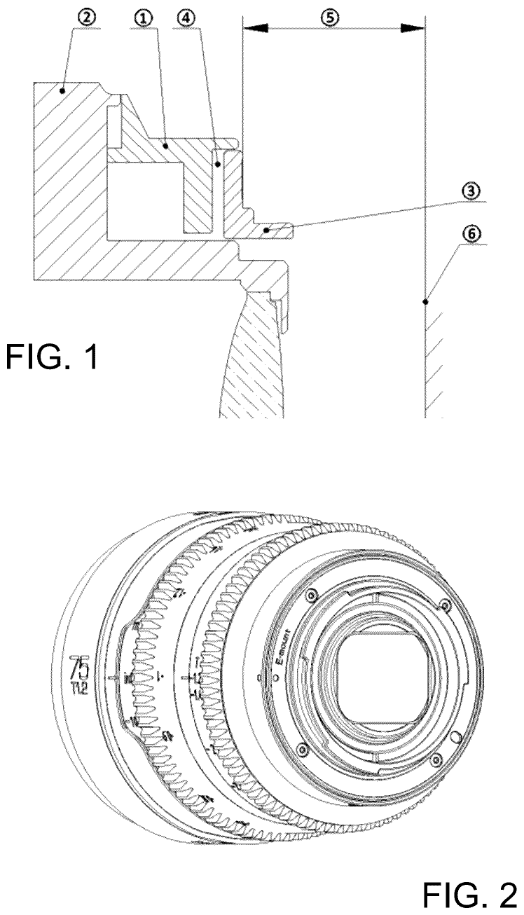

Reference characters used in the figures: 1. Lens barrel; 11. Limiting structure; 2. Connection sleeve; 21. Main body of connection sleeve; 22. First connecting edge; 23. Second connecting edge; 3. Axial adjustment clearance; 4. Bayonet cylinder; 41. Fixed sleeve mounting section; 42. Extended portion of fixed sleeve; 421. Step mating surface; 5. Bayonet component; 6. Screw; 7. Sealing ring; 8. Flange distance; 9. Image plane; 10. Screw.

### DETAILED DESCRIPTION

The technical solution of the embodiments of the invention will be clearly and comprehensively described below with reference to the accompanying drawings. It should be noted that the described embodiments constitute only a portion of the embodiments of the invention's implementation, not all possible implementations. Based on these embodiments, any other implementations obtained by ordinary skilled persons in the art without making inventive efforts fall within the scope of protection of the embodiments of the invention.

In the description of embodiments of the invention, it should be clarified that terms such as “center”, “up”, “down”, “left”, “right”, “vertical”, “horizontal”, “inside”, and “outside” indicate directional or positional relationships based on the orientation shown in the accompanying drawings. These terms are used for convenience in describing the embodiments of the invention and simplifying explanations, not to imply that the described devices or components must possess specific orientations, structural configurations, or operational methods. Therefore, they should not be construed as restrictive limitations of the embodiments of the invention. Additionally, terms like “first”, “second”, and “third” are used solely for descriptive purposes and should not be interpreted as indicating relative importance.

In the description of embodiments of the invention, it should be clarified that unless otherwise explicitly specified or limited, the terms “installation”, “connected”, and “connection” shall be interpreted broadly. These may refer to fixed connections, detachable connections, or integrated connections; mechanical connections or electrical connections; direct connections or indirect connections through intermediaries; or internal communication between two components. For ordinary skilled persons in the art, the specific meanings of these terms within embodiments of the invention may be understood based on specific contexts.

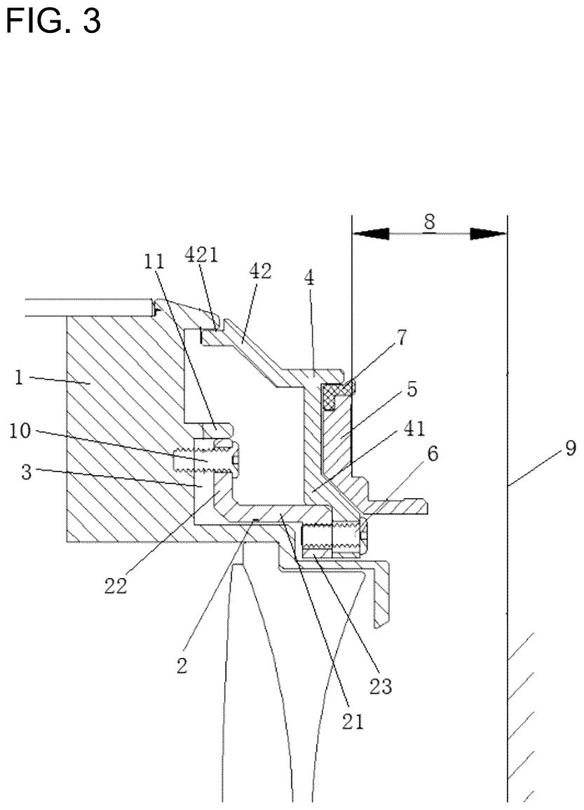

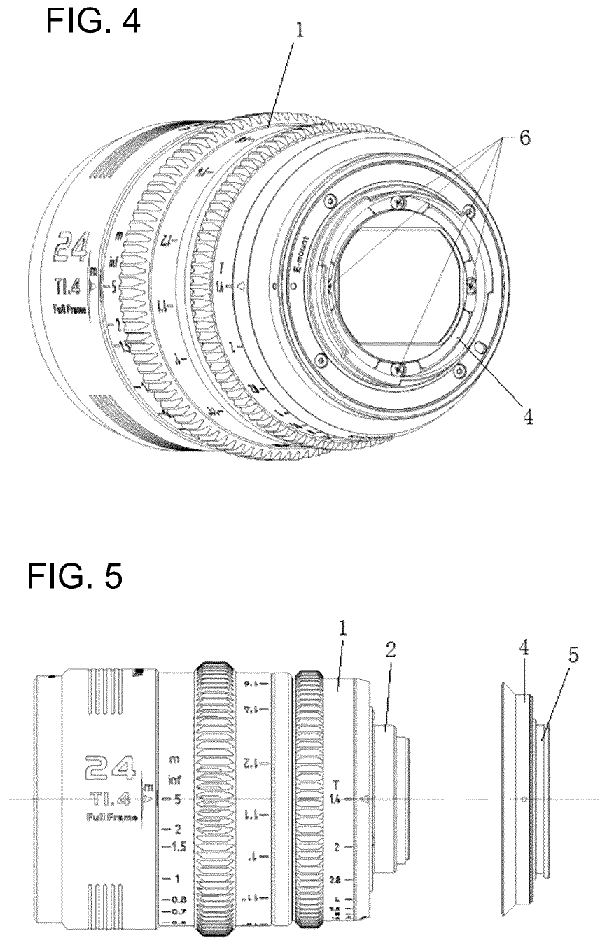

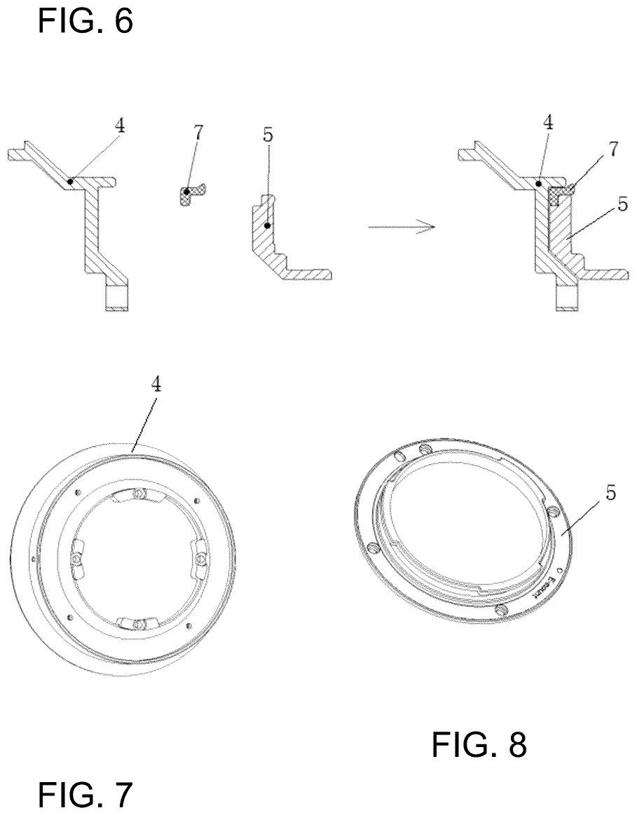

As shown in FIGS. 3-8, this interchangeable lens features a lens body and a bayonet assembly. The lens body consists of an integrated barrel 1 and a connecting tube 2, with an axial adjustment clearance 3 between them. The bayonet assembly includes a bayonet housing 4 and a bayonet component 5. The housing 4 is detachably mounted on one side of the connecting tube 2 via screw 6, while the bayonet component 5 is fixedly connected to the housing 4 and remains non-removable, serving as the camera's mounting component.

This interchangeable lens features a pre-manufactured lens barrel 1 and connector tube 2 that are fixed as a single unit with non-removable alignment clearance 3. When changing the lens's bayonet component 5 to match different cameras, simply remove screw 6 between the locking bayonet tube 4 and connector tube 2 for quick replacement. By relocating the traditional pre-manufactured alignment clearance 3 between the bayonet and lens body to the lens barrel and connector tube, the bayonet assembly remains permanently fixed during replacement. This design ensures no impact on alignment accuracy or pixel quality when disassembling/buying new lenses, while maintaining operational functionality without compatibility issues.

Specifically, the bayonet assembly includes a sealing ring 7 with a gasket positioned between the bayonet cylinder 4 and bayonet component 5. The sealing ring 7 ensures tight installation of bayonet component 5 on the solid cylinder 4, guaranteeing precise positioning accuracy. The bayonet assembly, consisting of the solid cylinder 4, sealing ring 7, and bayonet component 5, becomes permanently fixed during assembly. This design replaces the original bayonet component 5, eliminating the need for disassembly when replacing it later. The screw 6 refers to one or more exposed cross-shaped screws on the lens's outer surface. Users may directly remove these screws to replace the entire bayonet assembly, achieving the purpose of changing the bayonet.

Due to variations in camera brand mounts ‘dimensions and the differing flange distances between mount 5 and imaging surface 9, this interchangeable lens design accommodates multiple camera brands. The lens features four distinct mount types (E-mount, Z-mount, RF-mount, L-mount) with corresponding mount sleeves 4, ensuring proper alignment with each camera's flange distance 8. Notably, these lenses maintain a universal mount assembly across focal lengths (15 mm/24 mm/35 mm/50 mm/75 mm), enabling seamless interchangeability between lenses of different specifications, thereby expanding users’ creative possibilities.

In certain embodiments, the lens barrel 1 serves as a cylindrical housing for mounting lenses. The axial end of the lens barrel 1 near the bayonet assembly features a stepped structure, with the connecting tube 2 coaxially fixed at this stepped structure. The connecting tube 2 comprises: a main body 21 sleeved around the central pillar of the lens barrel 1; a first connecting edge 22 extending radially outward from one end of the main body 21; and a second connecting edge 23 extending radially inward from the opposite end of the main body 21. The first connecting edge 22 is positioned opposite the axial end face of the lens barrel 1, with an axial adjustment gap 3 formed between them. Several shims (not shown in the figure) are placed at this gap. The connecting tube 2 is secured to the axial end face of the lens barrel 1 via screws 10 passing through it and the shims. The bayonet fixed cylinder 4 is detachably connected to the second connecting edge 23 via screw 6, forming a rigid joint between them. During pre-factory assembly of the lens barrel 1 and connecting tube 2, precise control of the axial adjustment gap 3 may be achieved by adjusting the number and thickness of shims and tightening the screws 10, ensuring pixel quality remains unaffected when the bayonet assembly is removed.

Furthermore, a containment chamber is formed between the axial ends of the card slot solid cylinder 4 and lens cylinder 1, with the connecting tube 2 positioned within this chamber. This configuration enables an internal design for the connecting tube 2, screw 10, and washer, effectively preventing external moisture and dust from entering the chamber and compromising the locking performance of the screw 10 and washer. For instance, prolonged exposure to air and moisture may cause slight elastic deformation in the washer. Such minor changes could lead to slight loosening of the screw 10's locking mechanism, resulting in altered axial adjustment clearance 3 that affects lens imaging quality. The internal design of the connecting tube 2, screw 10, and washer minimizes these potential issues by delaying such mechanical degradation.

In certain embodiments, the axial end face of lens barrel 1 is provided with a limiting structure 11 extending toward the bayonet assembly, which abuts against the outer peripheral wall of first connecting edge 22. The installation of this limiting structure 11 on lens barrel 1 further prevents positional loosening of connecting tube 2.

In certain embodiments, the snap-fit or bayonet cylinder 4 comprises a mounting portion 41 for securing the bayonet component 5, and an extension portion 42 extending outward from the mounting portion 41 to cover the outer edge of the lens barrel 1. The extension portion 42 features a stepped mating surface 421 at its end facing the lens barrel 1, which cooperates with the lens body. This configuration significantly enhances the sealing performance of the housing cavity.

In summary, the interchangeable lens with detachable mounting slots introduced in embodiments of the invention embodiment breaks away from the conventional non-removable design concept. By separating the connection between the mounting slot and the lens body, it achieves a replaceable design for the lens's mounting slot while maintaining its relative position with the lens body. This innovation ensures pixel quality remains unaffected post-replacement, eliminates functional degradation or compatibility issues, and features a simple structure with low cost and high feasibility. Furthermore, the modular design of components like the mounting slot enables interchangeability across lenses with different focal length specifications, thereby facilitating seamless replacement of mounting slots throughout the lens series.

Clearly, the embodiments described above are provided for illustrative purposes and are not intended to limit the scope of implementation. Those skilled in the art may make various modifications or variations based on the described examples. It is neither necessary nor possible to exhaustively enumerate all possible implementations. Any obvious modifications or variations derived from this disclosure remain within the scope of protection of the present utility model.

What is claimed is:

1. A lens with an interchangeable bayonet comprising:
a lens body comprising a fixed lens barrel (1) and a connecting tube (2), and an axial adjustment gap (3) is disposed between the connecting tube (2) and the lens barrel (1);
a bayonet assembly comprising a bayonet cylinder (4) and a bayonet component (5), wherein the bayonet cylinder (4) is removably connected to one side of the connecting tube (2) via a screw (6), and
wherein the bayonet component (5) is fixedly attached to and not removable from the bayonet cylinder (4), wherein the bayonet component (5) is configured to connect to a camera.

2. The lens with interchangeable bayonet according to claim 1, wherein the clamp assembly further comprises a sealing ring (7) with a sealing pad disposed between the clamp solid cylinder (4) and the clamp (5).

3. The lens with interchangeable bayonet according to claim 1 is wherein the screw (6) is a cross-shaped screw exposed on the outer surface of the lens.

4. The lens with interchangeable card slots according to claim 1 is wherein the card slot (5) is any one of E card slot, Z card slot, RF card slot and L card slot.

5. The lens with interchangeable bayonet according to claim 1 is wherein the lens barrel (1) is a barrel for mounting the lens, and the connecting barrel (2) is coaxially fixed on the axial end of the lens barrel (1).

6. The lens with interchangeable bayonet according to claim 5 is wherein a containment cavity is formed between the bayonet cylinder (4) and the lens cylinder (1), and the connecting tube (2) is located in the containment cavity.

7. The lens with interchangeable bayonet according to claim 6 is characterized by: the lens barrel (1) having a stepped structure near the axial end of the bayonet assembly, and the connecting sleeve (2) being fixedly connected to the stepped structure of the lens barrel (1). The connecting sleeve (2) comprises: a main body (21) sleeved around the central column of the lens barrel (1), a first connecting edge (22) extending radially outward from one end of the main body (21), and a second connecting edge (23) extending radially inward from the other end of the main body (21). The first connecting edge (22) is positioned opposite to the axial end face of the lens barrel (1) and is secured to the axial end face via a screw (10), with the gap between the first connecting edge (22) and the axial end face serving as the axial adjustment clearance (3). The bayonet solid sleeve (4) is removably connected to the second connecting edge (23) via a screw (6), while the connection between the bayonet fixing sleeve and the second connecting edge (23) maintains a rigid joint.

8. The lens with interchangeable bayonet according to claim 7 is wherein the axial end face of the lens barrel (1) is provided with a limiting structure (11) extending toward the bayonet assembly, and the limiting structure (11) is abutted against the peripheral wall of the first connecting edge (22).

9. The lens with interchangeable lugs according to claim 6 is characterized by: the lugs solid cylinder (4) comprising a fixing sleeve mounting portion (41) for securing the lugs (5), and a sleeve extension portion (42) extending outward from the fixing sleeve mounting portion (41) toward the peripheral edge of the lens body and covering the outer side of the connecting sleeve (2).

10. The lens with an interchangeable bayonet according to claim 9 is wherein the fixed cylinder extension portion (42) has a stepped mating surface (421) at the end facing the lens barrel (1) which cooperates with the lens barrel (1).
